(19) United States
(12) Patent Application Publication
(10) Pub. No.: US 2007/0192645 A1
(43) Pub. Date: Aug. 16, 2007

(54) Battery management system chip and data-accessing method of the same

(75) Inventors: Chang-Yu Ho, Hsinchu Hsien (TW); Yung-Ming Tsai, Taipei (TW)

Correspondence Address: TROXELL LAW OFFICE PLLC, 5205 LEESBURG PIKE, SUITE 1404, FALLS CHURCH, VA, 22041, US

(73) Assignee: Neotec Semiconductor Ltd., Hsinchu Hsien (TW)

(21) Appl. No.: 11/512,433

(22) Filed: Aug. 30, 2006

(30) Foreign Application Priority Data
Feb. 14, 2006 (TW) 95104943

(51) Int. Cl. G06F 1/32

(52) U.S. Cl. 713/321

(57) ABSTRACT

A battery management system includes a flash memory chip having a smart battery management program and a microprocessor. An interface model (I/F module) is installed in the microprocessor as a bridge between the flash chip and the microprocessor. The I/F module includes a data register and an address register as a data buffer and address buffer, respectively, between the CPU and the flash chip. The I/F module also includes a logic control circuit to generate signals for the flash chip to read and program.

### BACKGROUND OF THE INVENTION

(1) Field of the Invention

The invention relates to a battery management system, and more particularly to a battery management system chip having a die-stacked memory and a data-accessing method to operate the chip.

(2) Description of the Prior Art

Most of electric portable devices are powered by batteries. However, due to limited accommodation space available in the portable device, the battery capacity for the device is also extremely limited. Equally importantly, to the portable device, the power consumption rate is also another issue concerning the battery. Currently, in the modern portable device, a battery management system chip is usually adopted to enhance the power efficiency of the battery. The battery management system chip can control the volume, operation temperature, recharging state, recharging count and some other important parameters and detection programs of the battery such as a lithium battery. In particular, a smart battery management system chip can further update its operational parameters according to the working environment and conditions.

Generally, the battery management system chip can be a battery management microprocessor having a read-only memory (ROM) to store boot loaders. The microprocessor may also include programs in monitoring the volume, operation temperature, recharging state, recharging count and so on. The states of the battery can be stored into a random access memory (RAM) of the battery management microprocessor.

However, due to some chemical aging instincts in the battery usage, the detected data on the residual capacity and the recharging state, obtained by the conventional monitoring programs, may be biased gradually and become unreliable. That is the reason of the appearance of the aforesaid smart battery management system chip. The smart battery management system chip includes a learning program for compensating operation parameters and storing the revised operation parameters according to the working environment and the service time of the battery. By providing the learning program, the calculations of the recharging state and the residual capacity can be more reliable. Yet, because the contain of the ROM can't be renewed and the RAM can't hold any data at a power-off state, a simple constructed battery management system chip is usually unable -to afford a complete learning program that can quickly update the operation parameters so as to achieve correct and real-time battery information.

Obviously, a flash memory that can store the data for at least a decade without consuming electricity is one of the batter choices to store the learning program and the battery parameters. Therefore, to integrate the flash memory into the conventional battery management system chip for improving the operations in monitoring the battery is the major topic of the current effort.

### SUMMARY OF THE INVENTION

Accordingly, it is an object of the present invention to provide a battery management system that includes a flash memory chip (or called a flash chip) for storing a battery learning management program.

In the present invention, the flash chip is integrated to a battery management microprocessor (CPU) by wire bonding or a multi chip package. The communication between the flash chip and the microprocessor can be done through a flash interface module. The flash interface module further includes a first multiplexer, a second multiplexer, a data register, an address register, a control register, a control logic circuit and a decoder.

In the present invention, a device data bus is included to signally communicate between the CPU and the data register, including the transmission of address data from the CPU to the data register. Every address of the flash chip is transmitted twice, one by little endian and another by big endian. The CPU can retrieve data from a read-only memory (ROM) through an instruction data bus. The first multiplexer is to determine whether the CPU is to retrieve data from the data register or that from the ROM. Through an instruction address bus, the CPU can transmit instruction addresses to the ROM and the address register.

Further, a flash data bus is included to communicate between the flash chip and the data register, and a flash address bus is included to transfer an address of the address register to a predetermined address in the flash chip. The second multiplexer is used to determine whether the address to be dumped to the address register is from the instruction address bus or from the device data register. Also, according to the instruction of the CPU, the decoder can generate enable flags to choose part of the control registers to be transmitted to the control logic circuit for further calculation so as to generate control signals for the first multiplexer, the address register, the data register and the flash chip. In the present invention, data to the control registers is transmitted from the device data bus.

All these objects are achieved by a battery management system chip and a data-accessing method of the chip described below.

### BRIEF DESCRIPTION OF THE DRAWINGS

The present invention will now be specified with reference to its preferred embodiment illustrated in the drawings, in which:

FIG. 1 is a block circuit diagram of a preferred battery management system chip in accordance with the present invention;

FIG. 2 shows a typical time sequence of the battery management system in accordance with the present invention; and

FIG. 3 shows a time sequence of a write operation from the battery management system to a flash chip in accordance with the present invention.

### DESCRIPTION OF THE PREFERRED EMBODIMENT

The invention disclosed herein is directed to a battery management system chip and a data-accessing method of the battery management system chip. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

By integrating a flash chip into a battery management microprocessor chip according to the present invention, the product can have advantages of the flash chip in repeatedly programming, erasing and storing data without consuming electricity. Thereby, the integrated chip is suitable to store parameters for program application and battery management. In the present invention, an I/F module is used to separate spatially but connect electrically the flash chip and the conventional battery management microprocessor chip. Such a stacking arrangement is applicable to various flash chips and microprocessor chips already in the marketplace and can also help to reduce the development time of a new batter management system chip.

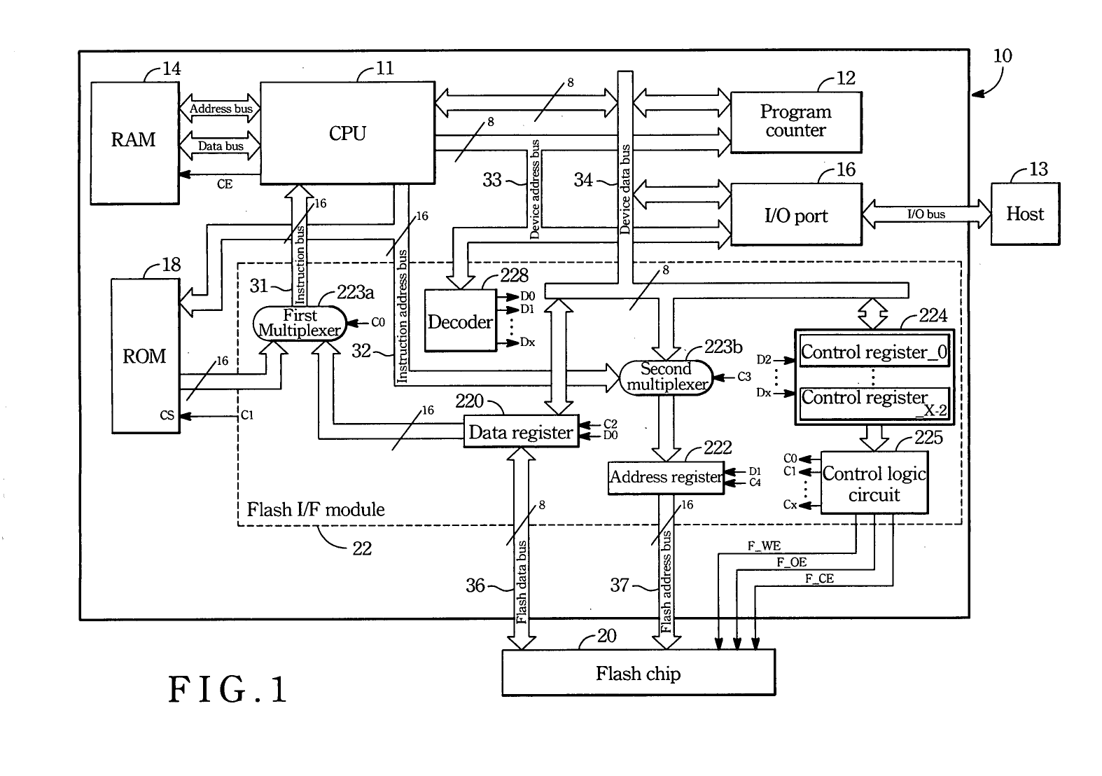

Referring now to FIG. 1, a block circuit diagram of a preferred battery management system chip in accordance with the present invention is shown. The battery management system chip includes at least a CPU 11, a clock 12, a RAM 14, an I/O port 16, a ROM 18 and an I/F module 22. The clock 12 herein can be selected from the group of counters, time pulse generators, analog-to-digit (A/D) converters and any combination of aforesaid devices. The A/D converter can convert the current, potential, and temperature of the lithium battery into respective digital signals for further being read by the battery management system chip. The I/F module 22 is used to connect the conventional battery management microprocessor to the flash memory 20. According to one embodiment of the present invention, the ROM 18 can store pertinent application programs in system programming and battery management, while the learning programs are stored in the flash chip 20. Certainly, the flash chip 20 can also include some application programs related to system programming and battery management. Upon such an arrangement, system booting can also achieved by a boot loader in the flash chip 20, and thus users of the system chip of the present invention can feel free to on-line download new versions of the application programs and the learning programs.

According to the preferred embodiment of the present invention as shown, the battery system microprocessor 10 is a 16-bit battery management microprocessor including an instruction data bus 31 having 16 data lines, an instruction address bus 32 having 16 address lines, a device address bus 33 having 8 device address lines, and a device data bus 34 having 8 device data lines. That is to say that the battery management microprocessor 10 can provide a 32 k addressing capacity, which is sufficient to process addressing upon the ROM 18 and the flash chip 20. In the present invention, operations among the CPU 11, the I/O port 16 and the RAM 14 of the battery management microprocessor 10 are well known to the skill person in the art, and thus details related to the operations would be omitted herein.

According to one embodiment of the present invention, the flash I/F module 22 includes an address register 220, a data register 222, a first multiplexer 223a, a second multiplexer 223b, a control logic device 225, a decoder 228, and x-1 control registers 224. The first multiplexer 223a is used to determine whether the instruction to be read is from the ROM 18 or from the flash chip 20. The second multiplexer 223b is used to determine whether the 16-bit address stored in the instruction address bus 32 or the data (indirect address) stored in the 8-bit device data bus 34 is to be read by the address register 222.

Addresses and data to be written into the flash chip 20 are transmitted through the device data bus 34 having 8 data lines for indirect addressing. The device address bus 33 can transfer the address from the I/O port 16 or the instruction from the CPU 11 to the decoder 228 for decoding and further for generating enable flags D0 to Dx of the control register 224. In the present invention, contains of the control register_0 through the control register_x-2 are retrieved from the device data bus 34. The enable flags D2 to Dx, respectively to the control register_0 to the control register_x-2, are used to have the control logic device 225 generate C0 to Cx control bits and other control bits such as a write enable F_WE, an output enable F_OE and a chip enable F_CE. In particular, bit C3 is a select signal of the second multiplexer 223b, bit C0 is a select signal of the first multiplexer 223a, C4 and D1 are control signals of the data register 222, D0 and C2 are control signals of the address register 220, and C0 is a CS (chip select) signal to control the ROM.

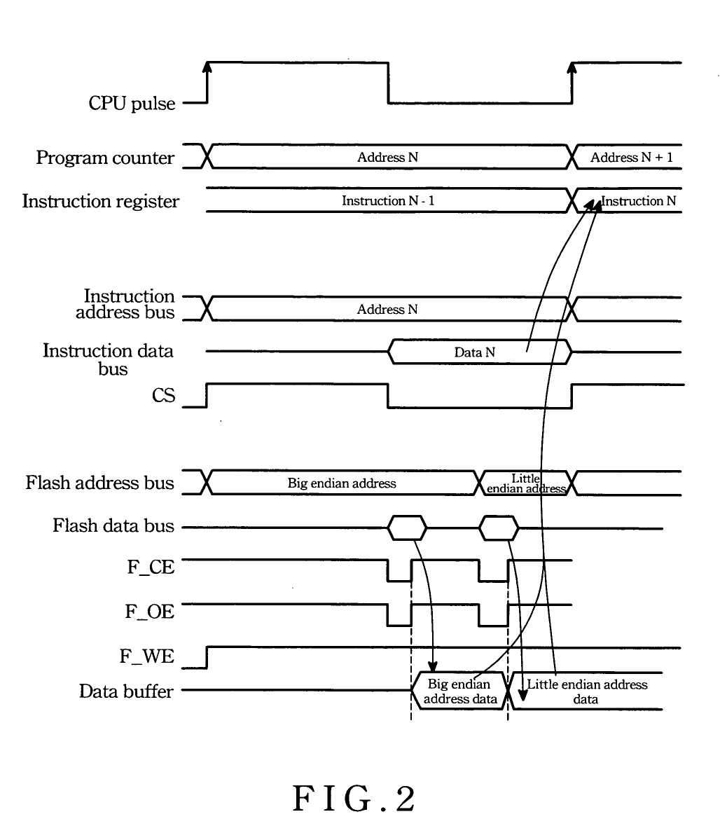

The start of the battery management system of the present invention is a well-known art. The CPU 11 executes the following instruction: directing the store address of the instruction address bus 32 to the lowest address of the ROM. At this lowest address, a jump instruction (for example, JMP to an address N) is executed. Refer also to FIG. 2. When the time pulse of the CPU is at the rise, a program counter in the CPU 11 will automatically shift to a next to-be-executed address, i.e. the address N. The program counter won't count to renew (generally by adding 1) until meeting the next CPU period. While the program counter counts, the CPU 11 would release the address N to the instruction address bus 32. Then, according to the address stored in the instruction address bus 32, an instruction at the address N of the ROM can be read. At the half period point of the CPU time pulse, the control logic 25 issues a chip select (CS) to the ROM 18. The fall of the CS time pulse implies that the ROM 18 is selected and sustained for a half period of the CPU time pulse so as to provide a sufficient time for transferring the contains of the address N of the ROM 18 to the instruction data bus 31. Till for the next rise of the CPU time pulse (as the program counter in the CPU 11 moves automatically to the next to-be-executed address, i.e. address N+1), the data in the instruction data bus 31 is used to update the contains of the instruction register (not shown in the figure) of the CPU 11. As shown in FIG. 1, for the first multiplexer 223a is located in a signal flow view 25 between the instruction data bus 31 and the CPU 11, the first multiplexer 223a will use the control signal C0 to select directly the ROM 18 as the instruction source for the CPU 11. Upon such an arrangement, a sequence of booting codes stored in the ROM 18 can be used to start the system.

In the case that the boot loader is stored in the flash chip 20 (i.e., the system can only be started by the flash chip 20), the instruction address will flow from the instruction address bus 32, the second multiplexer 223b, the address register and the flash data bus 26 to the flash chip 20 so as to instruct the flash chip 20 to read the instruction. The contains of the target address in the flash chip 20 can then be retrieved to the CPU 11 for executing a reading sequence of the booting codes and further for completing the booting process, through the data register 220, the first multiplexer 223a and the instruction data bus 31.

According to the specs of the conventional flash chip, the chip enable F_CE and the output enable F_OE are also provided when the contains of the address N of the flash chip 20 is read. On the other hand, in the present invention, the reading of the contains of the address N in the flash chip would be finished within a period of the CPU time pulse. The flash I/F module 22 issues the F CE and F_OE signals to the flash chip 20, respectively at the ½ and ¾ periods of the CPU time pulse, for transferring the contains of the address N in the flash chip 20 to the flash data bus.

It is well known that the power consumption of the battery management system of the portable apparatus is crucial. In the conventional design, the longer the F_CE and the F_OE are to be kept at lower level, the larger the power consumption is in the conventional flash chip. Therefore, without affecting the download data, the maintaining time of the F_CE and the F_OE should be kept as short as possible. Such a question can be resolved by introducing the data register 220 of the flash I/F module 22. According to one embodiment of the present invention, the maintaining time of the F_CE and the F_OE at the lower level can be shortened to ⅛ period of the CPU time pulse. That is why the system of the present invention is superior to the conventional design in power consumption. It is also noted that the maintaining time of the F_CE and the F_OE in accordance with the present invention can be adjusted to meet various requirements by a programmable delay circuit. After the F_CE and the F_OE experiencing the ⅛ period of the CPU time pulse at lower levels, the contains of the flash data bus can be read and be further used to latch in the data register 220 of the flash I/F module 22. After a period of the CPU time pulse, the contains of the data register 220 are now combined into a 16-bit contain, and this contain won't be loaded into the instruction register of the CPU 11 until the present of the next capture instruction from the CPU 11.

While in writing the flash chip 22, three possibilities must be discussed. In the case that the writing involves only partial updating of the parameters, the writing can be performed by the application program in the ROM and also requires the calculation instruction from the CPU 11. Also, in the case that the writing involves only partial updating of the parameters, the writing to the flash chip 20 can be performed by the application program stored in the flash chip 20 after the calculation of the CPU 11. Finally, in the case that the writing involves updating of a great amount of the contains of the flash chip 20, the data to be written is imported from an external host 13 through an I/O port 16.

Further, in any case of the aforesaid writing to the flash chip 20, the write protection upon the flash chip 20 needs to be removed in advance. Before the write protection can be removed, the F_CE and a write enable F_WE need to be kept at lower levels, but the F_OE at a higher level.

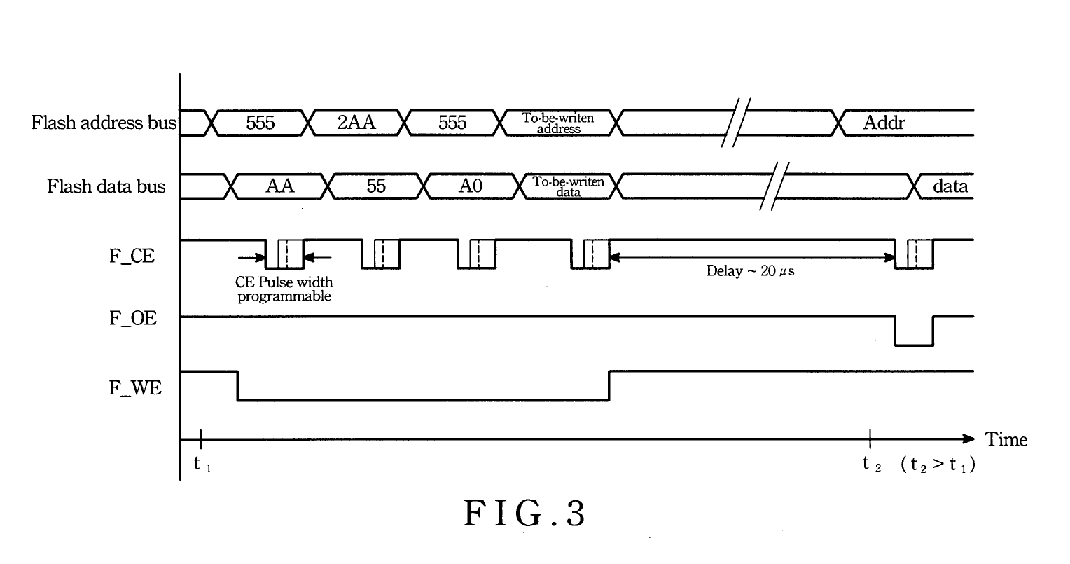

Therefore, after the host transfers a command to the CPU 11 via the I/O port 16 and the device data bus 34 and after the CPU confirms that the command is a write request to the flash chip 20, the CPU is suspended. Then, some predetermined write instructions in the CPU is forwarded to the decoder 228 through the device address bus 33 so as to generate enable flags D0 to Dx of the control register. In addition, the CPU 11 also forwards some other write instructions to the control register 224 via the device data bus 34. After the enable flags D2 to Dx dumps contains of some control registers 224 to the control logic circuit 225 so as to generate the F_CE and F_OE to the flash chip 20, the CPU 11 is then suspended and the host 13 dominates. Till the job in flash chip 20 is done, the CPU 11 can regain control from the host 13, as shown in FIG. 3.

In the present invention, a pulse generation circuit (not shown in the figure) can be added into or after the control logic circuit 225 so as to adjust the pulse width of the F_CE and F OE (control signals). Upon such an arrangement, a preferable tradeoff state between the energy saving and the stable data accessing can be obtained.

In the present invention, the written address and the to-be-written data of the flash chip 20 are obtained through the device data bus 34 having 8 data lines (indirect addressing). Addressing of the flash chip 20 (including the little endian and the big endian) and the retrieving of the flash chip 20 are both needed to be completed in the same CPU period.

Referring now to both FIG. 1 and FIG. 3, at the lower level of the F_VVE, the device data bus 34 loads the little and big endians 55 and 05 into the address register 222 for combination. The combined endians are then fed to the flash address bus 37. The device data bus 34 then loads AA of the little endian into the data register 220 and the address register 222. As shown in FIG. 3, every time prior to dumping the contains of the address register 222 and the data register 220 respectively to the flash address bus and the flash data bus, the contains of the address register 222 always already has two endians and the data register 220 has an endian. Only at this timing, the control logic circuit 225 can issue a lower-level pulse as the F_CE to the flash memory 20. In FIG. 3, the dashed line in the F_CE pulse of the present invention implies that the width of the lower level thereof is adjustable. Then, the device data bus 34 feeds the big endian 02 into the address register 222. The contains of the data register 220 and the address register 222 are dumped respectively to the flash data bus 36 and the flash address bus 37. Thereafter, the device data bus 34 loads the little endian 55 into the address register 222 and the data register 220. After the device data bus 34 reloads the big endian 05 to the address register 222, the contains of the data register 220 and the address register 222 are dumped again to the flash data bus 36 and the flash address bus 37. As soon as the device data bus 34 reloads the little endian 05 into the data register 220, the write protection of the flash chip is then removed. Then, the device data bus 34 firstly loads the little and big endians (to be written to the flash chip 20) to the address register 222, and secondly loads a little endian (also to be written to the flash chip 20) to the data register 220. Thereafter, the contains of the data register 220 and the address register 222 are dumped respectively to the flash data bus 36 and the flash address bus 37. The aforesaid dumping operations need to cooperate with the F_CE pulse, as shown in FIG. 3. Upon such a sequence, the complete endians of data are written into the flash chip 20. As shown, after a 20 μs delay for the F_WE to change from a lower level to a higher level, the aforesaid operation of removing the write protection is repeated to perform another data writing of the next endian.

By providing the battery management system in accordance with the present invention, following advantages can be obtained.

For the flash chip is stacked outside the battery management system chip to store some important parameters for performing learning or detection programs, the market appearance of the portable products can be true right after the completion of the system hardware chips and the basic software programs. It is no need to wait a final version of the software programs to be appeared. In addition, for the design of the present invention to separate the flash chip from the system chip, the 8-bit flash chip already in the market place can also be the flash chip of the present invention, such that the application of the present invention can easily prevail.

While the present invention has been particularly shown and described with reference to a preferred embodiment, it will be understood by those skilled in the art that various changes in form and detail may be without departing from the spirit and scope of the present invention.

I claim:

1. A battery management system, comprising:
a flash chip for storing learning programs related to battery management; and
a battery management microprocessor, further including:
a CPU;
a ROM for storing application programs related to the battery management; and
a flash I/F module, further including a first multiplexer, a data register, an address register, a plurality of control registers, a control logic circuit and a decoder;
wherein the CPU communicates with the data register via a device data bus, the CPU transmits addresses to the data register via the device data bus, the CPU retrieves data from the ROM via an instruction data bus, the CPU retrieves instructions of the flash chip from the data register via the instruction data bus, the first multiplexer is used to determine whether the CPU is to retrieve data from the data register or from the ROM, the CPU transmits instruction addresses to either the ROM or the address register via an instruction address bus, the flash chip communicates with the data register via a flash data bus, the address register transmits addresses to predetermined addresses in the flash chip via a flash address bus, and, according to the instruction of the CPU, the decoder generates enable flags to choose part of the control registers to be transmitted to the control logic circuit for further calculation so as to generate control signals for the first multiplexer, the address register, the data register and the flash chip; and wherein data to the control registers is transmitted from the device data bus.

2. The battery management system according to claim 1, wherein said control registers, said control logic circuit and said decoder are used to provide signals to remove a write protection of the said flash chip while in writing said flash chip.

3. The battery management system according to claim. 1, wherein said battery management microprocessor further includes an I/O port for inputting data to write into said flash chip.

4. The battery management system according to claim 1, wherein parameters of said learning program are updated by a data from the group of data from said CPU calculating an application program stored in said ROM, data from said CPU calculating another application program stored in said flash chip, and data importing from said I/O port.

5. The battery management system according to claim 1, wherein said device flash chip, said device data bus, said device address bus, and said flash data bus are 8-bit elements, and wherein said flash address bus, said CPU and said ROM are 16-bit elements.

6. The battery management system according to claim 5, wherein said address register is a 16-bit register to receive little endian addresses and big endian addresses transmitted from said 8-bit device data bus.

7. The battery management system according to claim 1, wherein said flash chip needs a write control signal to perform data writing, which the write control signal is generated by said control logic circuit, and wherein said control logic circuit also generates control bits to control operation of said flash I/F module.

8. The battery management system according to claim 1, further including a second multiplexer for determining whether an address to be dumped to said address register is from said instruction address bus or from said device data register.

9. The battery management system according to claim 1, wherein said control logic circuit further includes a pulse generation circuit for adjusting pulse widths of said control signals.
